(19) United States
(12) Patent Application Publication
(10) Pub. No.: US 2003/0018710 A1
(43) Pub. Date: Jan. 23, 2003

(54) System and method for providing devices in a home network with a service, and a system and method for receiving a service in a home network

(75) Inventor: Moon-Jeong Choi, Suwon-city (KR)

Correspondence Address: SUGHRUE, MION, ZINN, MACPEAK & SEAS, PLLC, Suite 800, 2100 Pennsylvania Avenue, Washington, DC, 20037-3213, US

(73) Assignee: SAMSUNG ELECTRONICS CO., LTD.

(21) Appl. No.: 09/985,827

(22) Filed: Nov. 6, 2001

(30) Foreign Application Priority Data
Apr. 17, 2001 (KR) KPA 2001-20551

(51) Int. Cl. G06F 15/16

(52) U.S. Cl. 709/203

(57) ABSTRACT

A system and a method for providing devices within a home network with a service. The system is connected to a home network in which a plurality of devices are connected to one another through the Internet, in order to provide a certain device in the home network with a service, and includes a database that stores address information about a home network that subscribes to the service, and information about a service recipient device within the home network. The system transmits a notifying message to the service recipient device prior to providing the service to confirm whether the service recipient device can receive the service or not, and provides the service recipient device with the service after receiving an affirmative response from the service recipient device.

### BACKGROUND OF THE INVENTION

1. Field of the Invention

The present invention relates to a method for providing a service via the Internet, and, more particularly, to a system and a method for providing a service to devices within a home network that transmits and receives the service based on information about the devices subscribed to the service, and a system and a method for receiving the service within the home network. The present application is based on Korean Patent Application No. 2001-20551 filed on Apr. 17, 2001, which is incorporated herein by reference.

2. Description of the Related Art

Recently, due to advanced communication technology, use of many information devices such as computers, faxes, modems, telephones, etc. in a network has exploded, especially in small office home offices (SOHOs) or homes. Here, for the convenience of explanation, the networks established in the SOHOs or the homes will be representatively called ‘home networks’ throughout this description.

The devices within a home network can use the service on line, i.e., through the Internet. For this, the devices in the home network can subscribe to an external server while on or off-line. The devices can also cancel the subscription to the external server while on or off line.

The service providing server then manages the registration of the subscriber devices on the basis of certain information, that is the home identification numbers and the device identification numbers, and provides service only to the registered subscriber devices. Once the identification number is given to a certain device, the identification number cannot be used for other devices.

The above-mentioned way, however, has a problem in that the service providing server has to process the subscription of each device in each home network to provide the service to the device. Accordingly, when the subscriber devices increase, the service providing server has to handle increased jobs of maintaining the subscriber devices and processing the service for the respective subscriber devices.

There is another inconvenience of the service recipient. That is, each new device has to newly subscribe to the service providing server to receive the same service that the other previously equipped devices in the home network receive.

There is the same inconvenience when any device cancels its subscription while receiving the same service from the service providing server.

Meanwhile, since the service providing server maintains the subscriber devices by IDs, there could be a serious problem if the IDs are exposed to those such as hackers who have a malicious intent to steal the IDs.

### SUMMARY OF THE INVENTION

The present invention has been made to overcome the above-mentioned problems of the related art, and accordingly, it is an object of the present invention to provide a system and a method thereof for providing devices within a home network with service in a manner that restricts the burden of maintenance that is increased due to addition or reduction of the devices subscribed to the same service, and also simplifying procedures for service reception, and a system and a method thereof for receiving the service in the home network.

The above-mentioned object is accomplished by a system connected to a home network in which a plurality of devices are connected to one another through the Internet, the system provides a certain device in the home network with a service, and, in accordance with the present invention, includes a database that stores address information about a home network that subscribes to the service and information about a service recipient device within the home network. The system transmits a notifying message to the service recipient devices prior to providing the service to confirm whether the service recipient devices can receive the service or not, and provides the service recipient device with the service after receipt of an affirmative response from the service recipient device. The notifying message contains additional identifying information of the service recipient device as well as information about an address of the home network to which the service recipient devices belong.

The additional identifying information is generally used for the devices of the same kind that intend to receive a service of the same type.

Further, the additional identifying information includes information about at least one of a device type, a device property, a user name, a vendor, a model name, and a serial number.

It is preferable that the service is a push service that provides a certain service to the service recipient devices repeatedly in a predetermined period.

The above object is also accomplished by a system for maintaining a plurality of devices connected in a home network, and for receiving a service from a service providing server existing outside of the home network in accordance with the present invention, including a database that stores dynamic IP addresses of devices within the home network as well as IDs of the devices, the devices corresponding to additional identifying information registered in the service providing server. The system receives a notifying message from the service providing server to confirm whether service recipient devices can receive the service or not. The notifying message contains the additional identifying information of the service recipient devices. When the system determines that there is a device that corresponds to the additional identifying information contained in the notifying message, the system converts the ID of the corresponding device into an IP address and then transmits a notifying message.

The above object is also accomplished by a method of a service providing server for providing a service, the service providing server connected to a home network through the Internet, the home network in which a plurality of devices are connected, the method of the service providing server, in accordance with the present invention, including the steps of (A) the service providing server storing address information about a home network subscribed to the service providing server for the service and also storing additional identifying information of a service recipient device of the home network, (B) transmitting a notifying message prior to providing the service to confirm whether the service recipient device can receive the service or not, the notifying message containing address information about a home network that the service recipient device belongs to, and also the additional identifying information, and (C) providing the service after receiving a response message from the service recipient device, the response message indicating that the service recipient device can receive the service.

The above object is also accomplished by a method of a lookup server for receiving a service from an external service providing server, the lookup server maintaining a plurality of devices connected in a home network, the method, in accordance with the present invention, including the steps of (a) storing IDs and dynamic IP addresses of devices of the plurality of devices that correspond to additional identifying information registered in the external service providing server, (b) receiving a notifying message from the service providing server to confirm whether a service recipient device can receive the service or not, the notifying message containing the additional identifying information about the service recipient device, and then determining whether there is a device corresponding to the additional identifying information that is contained in the notifying message, and (c) when it is determined that there is a device corresponding to the additional identifying information contained in the notifying message, converting an ID of the corresponding device into an IP address and transmitting the converted IP address.

The above object is also accomplished by a system for providing a home network with a service, the home network in which a plurality of devices are connected to one another, the system, in accordance with the present invention, includes a service providing server that stores address information about a home network subscribed to the service and also information about a service recipient device, the service providing server transmits a notifying message prior to providing the service to inquire about whether the service recipient device can receive the service or not, the notifying message containing address information about a home network that the service recipient device belongs to and also additional identifying information about the service recipient device, and a lookup server of the home network that stores an ID and a dynamic IP address of one of the plurality of devices that corresponds to the additional identifying information registered in the service providing server, the lookup server receives a notifying message from the service providing server and determines whether there is a device corresponding to the additional identifying information contained in the notifying message, and if there is any, the lookup server converts an ID of the corresponding device into an IP address and transmits the converted IP address. The service providing server provides the service after receipt of a response message from the service recipient device, which indicates that the service recipient device can receive the service.

### BRIEF DESCRIPTION OF THE DRAWINGS

The above-mentioned objects and features of the present invention will be more apparent by describing the preferred embodiment of the present invention in detail by referring to the appended drawings, in which

FIG. 1 is a view showing the construction of a system that provides devices in a home network with service in accordance with a preferred embodiment of the present invention;

FIG. 2 is a view showing one example of a database having a lookup server of FIG. 1; and

FIG. 3 is a flow chart for explaining a method for providing the home network with service in accordance with the preferred embodiment of the present invention.

### DETAILED DESCRIPTION OF PREFERRED EMBODIMENT

A detailed description according to the preferred embodiment of a system and a method thereof for providing devices in the home network of the present invention will follow by referring to the attached drawings.

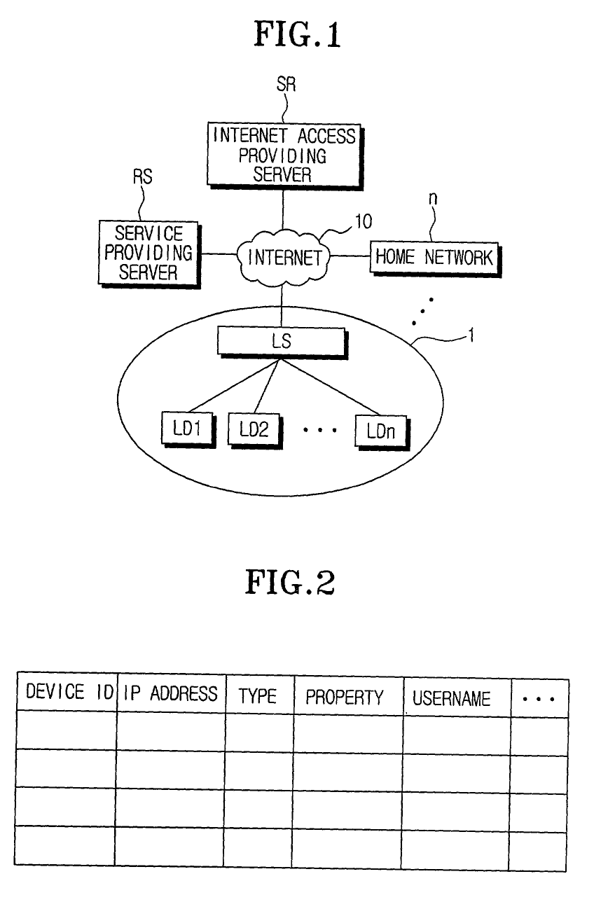

FIG. 1 is a view showing the construction of the system that provides the devices within the home network with the service in accordance with the preferred embodiment of the present invention.

As shown in FIG. 1, interconnected to each other through the Internet 10 are: a remote server (RS) for providing a service, a service root (SR) for providing access to the Internet 10, and a plurality of home networks (1-n). Each home network (1-n) includes a plurality of devices LD1, LD2, . . . , LDn and a lookup server (LS).

The remote server RS exists outside the home networks (1-n), and provides the service through the Internet 10. The remote server RS, in particular, provides the home network (1-n) with the service through the Internet 10. The remote server RS especially provides the subscriber home network with the service.

The remote server RS provides a push service. While the average service providing method provides the services upon request of the users, the push service is regularly provided to the subscriber devices in a predetermined period.

Examples of a push service can be found in the information providing service that are provided regularly, such as a ‘Today's Fortune Telling’, a ‘Stock Transaction’, a ‘Weather Report’, ‘Sports News’ or the like.

Another example can also be found in other types of devices such as a lamp that is set to be turned on in a predetermined period.

The remote server RS transmits a NOTIFY message to the subscriber home networks (1-n) in order to check whether the subscriber home networks (1-n) are placed in condition for service reception. The NOTIFY message notifies that the service is going to be provided.

It is preferable that the RS transmits the NOTIFY message to the subscriber home networks regularly in a predetermined period.

The NOTIFY message contains more than one piece of additional identifying information such as device type, device property, user name, vendor, model name, serial number, etc. Preferably, any information generally used for the devices of the same kind is used as the additional identifying information. The NOTIFY message is preferably written in XML format that has an adjustable tag.

After receiving an affirmative response message from the home networks (1-n) in response to the NOTIFY message, i.e., after receipt of ‘service reception possible’ message, the remote server RS provides the service.

Meanwhile, the service root SR connected to the Internet 10 allocates a global IP address to the home networks (1-n), and stores the IDs (e.g. URLs) of the home networks (1-n) and the global IP addresses allocated to the home networks (1-n).

After receiving the NOTIFY message from the remote server RS, the service root SR checks whether the home network recorded in the NOTIFY message is the subscribed home network.

If the recorded home network is the subscriber home network, the service root SR converts the home ID of the NOTIFY message into a corresponding IP address and transmits the converted IP address.

The lookup server LS of the home network receives the NOTIFY message from the service root SR.

The lookup server LS has the database as shown in FIG. 2.

The database of the lookup server LS stores and maintains relevant information about the devices connected in the home network inclusive of additional identifying information that corresponds with the remote server RS, such as the IDs, dynamic IP addresses, device type, device property, user name, vendor, model name, serial numbers, etc. The table generated in this way is updated during re-construction of the home network.

The lookup server LS further registers in the service root SR the IDs of the home networks and the global IP addresses currently allocated to the home networks, thereby enabling the communication between the home networks and the outside.

The lookup server LS searches the database for a device corresponding to the additional identifying information recorded in the received NOTIFY message.

If there is the device corresponding to the additional identifying information recorded in the NOTIFY message, the NOTIFY message is transmitted to the dynamic IP address of the corresponding device. There can be one, or more than one corresponding device.

Next, a method for providing the devices within the home network with the service will be described.

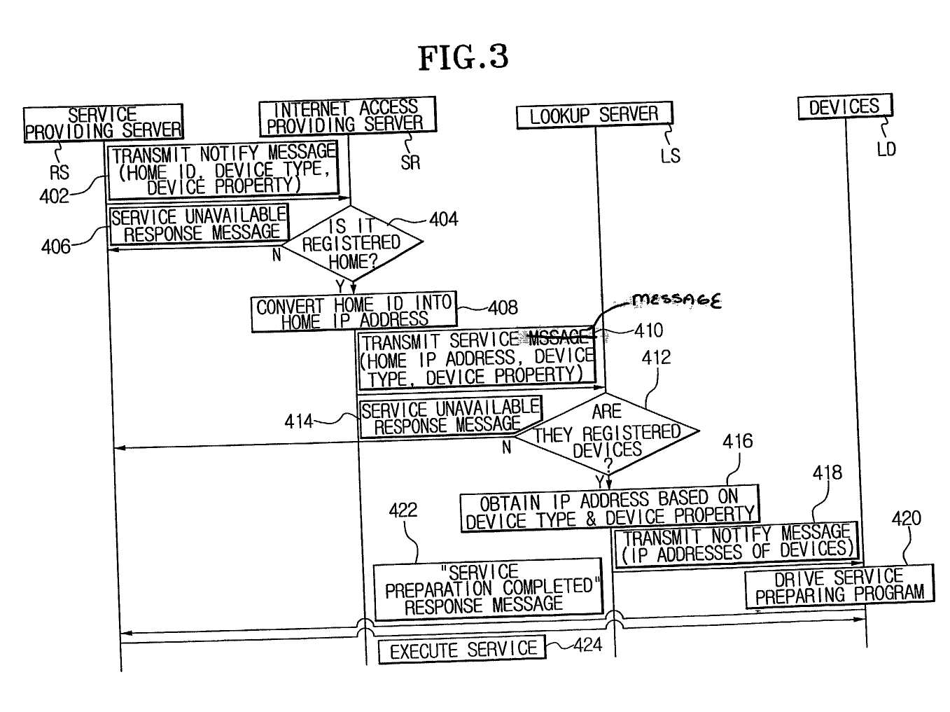

FIG. 3 is a flowchart for explaining the method for providing the home network with the service in accordance with the preferred embodiment of the present invention.

Here, let us suppose the remote server RS is the server that periodically provides the latest entertainment and sports news, and the ID of the subscriber home network is ‘Samsung 1’. Let us also suppose that the subscriber device is a computer having a resolution of 1280×720 p.

Prior to providing the service, the remote server RS transmits a NOTIFY message to the service root SR (step S402). The NOTIFY message records the ID of the home network to which the device corresponding to the additional identifying information belongs. The additional identifying information identifies the service recipient device. The NOTIFY message is,

```
<NOTIFY>
    <Home Id>Samsung1</Home Id>
    <Ld_type name = “Computer”>
      <Property name = “Resolution”>1280x720p</property>
    </Ld_type>
</NOTIFY>
```

Next, the service root SR receives a response message transmitted from the remote server RS, and confirms whether the home network designated by the received response message is a home network that is subscribed to the service root SR (step S404).

If the home network designated by the received response message is not subscribed to the service root SR, then the response message ‘Service Provision Impossible’ is transmitted (step S406).

If the home network designated by the received response message is determined to be the home network subscribed to service root SR in S404, the service root SR converts the ID of the home network designated by the NOTIFY message into the IP address of the corresponding home network (step S408), and transmits a NOTIFY message to the corresponding home network (step S410). The NOTIFY message contains the type and characteristic information about the service recipient device. The NOTIFY message also contains the IP address of the home network to which the service recipient device belongs. The NOTIFY message is,

<NOTIFY>

<Home IPaddress>111.222.333.444</Home IPaddress>
<Ld_type name = “Computer”>
<Property name = “Resolution”>1280x720p</property>

</Ld_type>
</NOTIFY>

Accordingly, the lookup server LS of the home network receives the NOTIFY message transmitted from the service root SR, and determines, based on the additional identifying information about the device designated by the received NOTIFY message, whether the device issubscribed to the lookup server LS or not (step S412).

If the device corresponding to the additional identifying information contained in the received NOTIFY message is not subscribed to the lookup server LS, the response message, ‘Service Provision Impossible’ is transmitted to the remote server RS (step S414).

If the device corresponding to the additional identifying information contained in the received NOTIFY message is the device subscribed to the lookup server LS, the ID of the corresponding device is obtained, and also the dynamic IP address of such obtained ID is obtained (step S416).

If there are two devices corresponding to the additional identifying information, with the IDs of PC1 and PC2, respectively, the dynamic IP addresses of the devices having IDs of PC1 and PC2 are obtained through the database. Then, a NOTIFY message is transmitted to the dynamic IP addresses of the service recipient devices (step S418). In this case, the NOTIFY message is,

```
<NOTIFY>
    <Home_IPaddress>111.222.333.444</Home_IPaddress>
      <Ld_IPaddress>xxx.xxx.xxx.xxx</Ld_IPaddress>
      <Ld_IPaddress>yyy.yyy.yyy.yyy</Ld_IPaddress>
</NOTIFY>
```

Here, the xxx.xxx.xxx.xxx is the IP address of the PC1, while yyy.yyy.yyy.yyy is the IP address of the PC2.

Accordingly, the service recipient devices that receive the NOTIFY message (i.e., devices PC1 and PC2) drive a service preparing program (step S420), and transmit to the remote server RS a response message (Result=SUCCESS, Reason=SERVICE_READY) indicating that they are ready for the service reception (step S422).

Then the remote server RS provides the responding devices with the corresponding service (step S424). In the description of the embodiment of the present invention, the algorithm for providing service between the service server and the client in a home is not mentioned. That is, the time that the service server begins to provide service according to the unforeseeable response of the client is not mentioned in the description of this embodiment.

As described above, with the system and method for providing the devices within the home network with service in accordance with the present invention, since there is no need to maintain the information separately to distinguish one device from another device of the same type, a burden of information maintenance is lessened.

Further, when a device that is similar to the existing subscriber device is added to receive the same service as the existing subscriber device receives, there is no need to separately subscribe to the remote server RS.

Further, since there is no leakage of information about the devices by the IDs that have been made during the subscription to the service, more strengthened security is guaranteed.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A system connected to a home network in which a plurality of devices are connected to one another through the Internet, the system provides a certain device in the home network with a service, comprising:
a database that stores address information about the home network that subscribes to the service, and information about at least one of a plurality of service recipient devices within the home network, wherein
the system transmits a notifying message to said at least one of the plurality of service recipient devices prior to providing the service, to confirm whether said at least one of the plurality of service recipient devices can receive the service or not, and provides the service to said at least one of the plurality of service recipient devices after receiving an affirmative response from said at least one of the plurality of service recipient devices, and wherein the notifying message contains additional identifying information of the service recipient devices as well as information about an address of the home network to which the plurality of service recipient devices belong.

2. The system of claim 1, wherein the additional identifying information is used for one of the plurality of devices of a same kind that intends to receive a same type of service.

3. The system of claim 1, wherein the additional identifying information includes information about at least one of a device type, a device property, a user name, a vendor, and a model name.

4. The system of claim 1, wherein the service is a push service that provides a certain service to said at least one of the plurality of service recipient devices repeatedly in a predetermined period.

5. A system for maintaining a plurality of devices connected in a home network, and for receiving a service from a service providing server existing outside of the home network, the system comprising:
a database that stores dynamic IP addresses of at least one of the plurality of devices within the home network as well as IDs of said at least one of the plurality of devices, said at least one of the plurality of devices corresponding to additional identifying information registered in the service providing server, wherein
the system receives a notifying message from the service providing server to confirm whether said at least one of the plurality of service recipient devices can receive the service or not, the notifying message containing the additional identifying information of said at least one of the plurality of service recipient devices, the system determines which of the plurality of devices corresponds to the additional identifying information contained in the notifying message, converts the IDs of the corresponding device into an IP address, and then transmits a response message.

6. The system of claim 5, wherein the additional identifying information is used for said at least one of the plurality of devices of a same kind that intends to receive a same type of service.

7. The system of claim 5, wherein the additional identifying information includes information about at least one of a device type, a device property, a user name, a vendor, and a model name.

8. The system of claim 5, wherein the service is a push service that provides a certain service to said at least one of the plurality of service recipient devices repeatedly in a predetermined period.

9. A method of a service providing server for providing a service, the service providing server connected to a home network through the Internet, the home network having a plurality of devices connected therein, the method of the service providing server comprising the steps of:
storing address information about a home network subscribed to the service providing server and storing additional identifying information of a service recipient device of the home network;
transmitting a notifying message prior to providing the service to confirm whether the service recipient device can receive the service or not, the notifying message containing address information about the home network that the service recipient device belongs to, and also containing the additional identifying information of the service recipient device; and
providing the service after receiving a response message from the service recipient device, the response message indicating that the service recipient device can receive the service.

10. The method of claim 9, wherein the additional identifying information is used for said at least one of the plurality of devices of a same kind that intends to receive a same type of service.

11. The method of claim 9, wherein the additional identifying information includes information about at least one of a device type, a device property, a user name, a vendor, and a model name.

12. The method of claim 9, wherein the service is a push service that provides a certain service to the service recipient device repeatedly in a predetermined period.

13. A method of a lookup server for receiving a service from an external service providing server, the lookup server maintaining a plurality of devices connected in a home network, the method comprising the steps of:
storing IDs and dynamic IP addresses of the plurality of devices that correspond to additional identifying information registered in the external service providing server;
receiving a notifying message from the service providing server to confirm whether a service recipient device can receive the service or not, the notifying message containing the additional identifying information about the service recipient device, and then determining whether there is a device corresponding to the additional identifying information that is contained in the notifying message; and
when it is determined that there is a device corresponding to the additional identifying information contained in the notifying message, converting an ID of the corresponding device into an IP address and transmitting the converted IP address.

14. The method of claim 13, wherein the additional identifying information is used for those of the plurality of devices of a same kind that intend to receive a same type of service.

15. The method of claim 13, wherein the additional identifying information includes information about at least one of a device type, a device property, a user name, a vendor, and a model name.

16. The method of claim 13, wherein the service is a push service that provides a certain service to the service recipient device repeatedly in a predetermined period.

17. A system for providing a home network with a service, the home network having a plurality of devices that are connected to one another, the system comprising:
a service providing server that stores address information about a home network subscribed to the service, stores information about a service recipient device, and transmits a notifying message prior to providing the service to inquire about whether the service recipient device can receive the service or not, the notifying message containing address information about the home network that the service recipient device belongs to and additional identifying information about the service recipient device; and
a lookup server of the home network that stores an ID and a dynamic internet protocol (IP) address of one of the plurality of devices that corresponds to the additional identifying information registered in the service providing server, receives the notifying message from the service providing server, and determines whether there is a device corresponding to the additional identifying information contained in the notifying message, and if there is such a device, the lookup server converts the ID of the corresponding device into an IP address and transmits the converted IP address, wherein
the service providing server provides the service after receiving a response message from the service recipient device, the response message indicating that the service recipient device can receive the service.
